(19) United States
(12) Patent Application Publication
(10) Pub. No.: US 2025/0255304 A1
(43) Pub. Date: Aug. 14, 2025

(54) HIGHLY TRANSMISSIBLE TERMITE CONTROLLING COMPOSITION

(71) Applicant: ZM Crop Protection Corporation, Tokyo (JP)

(72) Inventors: Ryo SAKITA, Osaka (JP); Yudai YAMASHITA, Osaka (JP); Toshiyuki KANKAWA, Tokyo (JP)

(21) Appl. No.: 18/857,056

(22) PCT Filed: May 25, 2022
(86) PCT No.: PCT/JP2022/021345

§ 371 Date: Oct. 15, 2024

(30) Foreign Application Priority Data
Apr. 26, 2022 (JP) 2022-072649

(51) Int. Cl. A01N 43/90; A01N 25/00; A01N 25/04; A01P 7/04

(52) U.S. Cl. CPC A01N 43/90; A01N 25/006; A01N 25/04; A01P 7/04

(57) ABSTRACT

Provided are a termite controlling composition characterized by containing dicloromezotiaz, which is a mesoionic compound, as an active ingredient and a method for using the same.

### TECHNICAL FIELD

The present invention is characterized by containing, as an active ingredient, dicloromezotiaz having an appropriate slow-acting property and extremely high insecticidal activity against termites, the present invention relating to a termite controlling agent composition having high transmission performance derived/caused by the slow-acting property and the high insecticidal activity; a termite controlling method using the composition and a method of using same. The present invention also relates to a method of using a composition containing, as an active ingredient, dicloromezotiaz as a composition for controlling termites.

### BACKGROUND ART

There are two types of termites: termites that inhabit dry wood; and termites classified as subterranean termites. Among these two types of termites, subterranean termites typically live in soil and build tunnels or termite trails from the soil to structural wood, which the subterranean termites use as a feeding site. That is, this type of termites has a characteristic of moving in soil. Termites of this type such as termites of the genus Reticulitermes and termites of the genus Coptotermes sometimes have 20,000 to 1,000,000 individuals in a single colony, and such a large number of individuals cause problems such as wood damage. In addition, tunnels built by these termites may be extended by 50 meters or more from the main center of a nest.

Termites form a colony centered around a queen. Worker termites engage in foraging and caring for the queen and larvae (such as trophallaxis and cleaning of bodies) as well as engage in trophallaxis and grooming (mutual licking) among the worker termites. Utilizing such behavior of termites, slow-acting compounds without a repellent action against termites, such as fipronil, chlorfenapyr, chlorantraniliprole and broflanilide are known as transmissible termite controlling agents considered to have a transmission effect in termite control. Termite controlling agents containing these compounds as active ingredients are commercially available (see Non Patent Document 1). In addition, a termite controlling agent containing, as an active ingredient, a neonicotinoid compound such as imidacloprid, dinotefuran, clothianidin or thiamethoxam is disclosed as a termite controlling agent, which has no slow-acting property and has a relatively fast-acting property but has a non-repellent action, and thus is considered to have a transmission effect similarly (see, for example, Patent Document 1, Non Patent Document 1 and Non Patent Document 2).

As used herein, the term “transmissibility” refers to a termite controlling property of an agent, when a termite-killing effect of the agent is transferred from one termite to another. Accordingly, for a compound to exhibit an effect through transmissibility, the termite-killing effect thereof against termite individuals is required to be slow-acting.

### PRIOR ART DOCUMENTS

### Patent Document

Patent Document 1: JP 2009-298776
Patent Document 2: JP 2013-501061
Patent Document 3: JP 2021-066661
Patent Document 4: JP 2004-105096

### Non Patent Document

Non Patent Document 1: The Pesticide Manual 18th Edition (British Crop Production Council, 2018)
Non Patent Document 2: “SHIBUYA INDEX-2005-10th Edition”, SHIBUYA INDEX collegium Summary of Invention

### Problem to be Solved

Known methods of controlling termites with chemical agents are broadly classified into: “wood treatment”, which involves applying an agent solution to wood or the like to control termites; “soil treatment”, where a chemical agent is sprayed onto soil below a floor or the like and onto a concrete surface or is sprayed, injected or mixed into soil around the outer periphery of a building to control termites; “termite trail treatment”, where termite trails built for movement of termites from a nest to a damage area are subjected to treatment (mainly using a dust formulation); and a “baiting system”, which involves burying or placing, in soil, a bait formulation (poison bait containing an insecticidal active ingredient, which is obtained by mixing an active ingredient with feed that termites prefer and is a formulation for feeding and killing termites) prepared by impregnating a wood or cellulose base material that termites prefer with an active ingredient or mixing an active ingredient with a wood or cellulose base material that termites prefer (for example, see Patent Document 4).

Among these controlling methods, the “soil treatment”, “termite trail treatment” and “baiting system” are three types of treatment methods that are expected to have a transmission effect aiming at eradicating a nest. In existing homes and the like, soil treatment methods are commonly used.

A termite controlling agent that exhibits three characteristics including a non-repellent action, a slow-acting property and high activity allowing expression of a high effect at an extremely low concentration is demanded for all of the “soil treatment”, “termite trail treatment” and “baiting system” when expression of a high transmission effect is expected.

When eradication of a colony through transmission is expected, it is necessary that worker termites that have directly contacted a termite controlling agent transmit the agent to other worker termites through trophallaxis and grooming (primary transmission), the transmission is repeated with the worker termites affected by the primary transmission further transmitting the effect of the agent to other worker termites (secondary transmission) and high insecticidal activity is maintained even after the secondary transmission.

However, existing termite controlling agents that are believed to have transmissibility transmit, to other termites, the effect of the agents from worker termites that have contacted the agents by directly spraying the agents to the bodies of the termites or by causing the termites to crawl over a layer (soil, paper filter or mortar) treated with the agents at a high concentration or in a large amount, for example. Thus, while existing termite controlling agents demonstrate sufficient efficacy in primary transmission from termites having crawled over a layer treated with the agents at a practical treatment concentration and in a practical treatment amount, the following problem arises: efficacy exhibition in secondary transmission and beyond are not sufficient. This is because, with respect to the existing termite controlling agents, practical treatment concentrations and amounts are not sufficient for transmission, and the insecticidal activity may not be maintained at a level required for secondary transmission and beyond by the slow-acting property.

Furthermore, with neonicotinoid termite controlling agents, there is the following problem: since neonicotinoid termite controlling agents are fast-acting, even primary transmission may be insufficient, much less secondary transmission, because other worker termites tend to avoid worker termites that die or exhibit abnormalities before the primary transmission effect is exhibited.

In addition, even with existing slow-acting termite controlling agents that are not neonicotinoid, there is an issue where the effect (moribund or dead) is exhibited in a termite individual that has contacted the agent sooner than the time required for the termite individual to return to the nest, and an effect of eradicating the colony cannot be fully expected. Therefore, there is a demand for an agent that is more slow-acting than existing slow-acting termite agents.

### Means to Solve the Problem

The present inventors have conducted extensive studies in order to create a novel termite controlling agent which has a non-repellent action against termites, which has, as an active ingredient, a compound having a more slow-acting property and higher activity than existing termite controlling agents and which is expected to have an effect of eradicating colonies through a high transmission effect. As a result, the present inventors have found that, when dicloromezotiaz is used as an active ingredient, remarkable transmissibility superior to existing agents is provided particularly in practical usage and in a practical dose of a frequently used soil treatment agent and have completed the present invention.

That is, the present invention relates to:
[1] A composition for controlling termites, comprising an effective amount of dicloromezotiaz, for controlling termites using transmissibility of dicloromezotiaz;
[2] the termite controlling agent composition according to [1], in a formulation of any of a liquid, an emulsifiable concentrate, an aqueous suspension, a rod formulation compressed into a stick form or a chalk form, microcapsules, a dust formulation, a granule and a bait formulation;
[3] the termite controlling agent composition according to [1] or [2], wherein the formulation is any of a liquid, an emulsifiable concentrate and an aqueous suspension;
[4] the termite controlling agent composition according to any one of [1] to [3], wherein the formulation is a liquid, an emulsifiable concentrate or an aqueous suspension, and the termite controlling agent composition comprises 0.01 to 50 parts by weight of dicloromezotiaz;
[5] the termite controlling agent composition according to [1] or [2], wherein the formulation is a granule;
[6] the termite controlling agent composition according to any one of [1], [2] and
[5], wherein the formulation is a granule, and the termite controlling agent composition comprises 0.01 to 1 part by weight of dicloromezotiaz based on 100 parts by weight of the granule;
[7] the termite controlling agent composition according to [1] or [2], wherein the formulation is a dust formulation;
[8] the termite controlling agent composition according to any one of [1], [2] and
[7], wherein the formulation is a dust formulation, and the termite controlling agent composition comprises 0.1 to 5 parts by weight of dicloromezotiaz based on 100 parts by weight of the dust formulation;
[9] the termite controlling agent composition according to [1] or [2], wherein the formulation is a rod formulation, or a bait formulation comprising a bait as feed for termites prepared by impregnating a wood material and/or a cellulose base material with an active ingredient, and/or by mixing the active ingredient, into a solid;
[10] the termite controlling agent composition according to [1] or [2], wherein the formulation is a bait formulation, and the termite controlling agent composition comprises 0.1 to 10 parts by weight of dicloromezotiaz based on 100 parts by weight of the bait formulation;
[11] a method of controlling termites using the termite controlling agent composition according to any one of [1] to [10];
[12] the method of controlling termites according to [11], wherein the method is any of soil treatment, where the composition is sprayed or mixed into soil, termite trail treatment, where termite trails are subjected to treatment with the composition and a baiting system, where the bait formulation comprising the composition is placed in soil;
[13] the method of controlling termites according to [11] or [12], comprising a step of performing soil treatment with a rod formulation comprising the termite controlling agent composition or a step of performing soil treatment by spraying/mixing, into soil, the termite controlling agent composition in any of a liquid, an emulsifiable concentrate, an aqueous suspension and a granule;
[14] the method of controlling termites according to [11] or [12], comprising a step of performing termite trail treatment by treating termite trails with the termite controlling agent composition in a dust formulation;
[15] the method of controlling termites according to [11] or [12], comprising the baiting system where the bait formulation of the termite controlling agent composition is placed in soil; and
[16] the method of controlling termites according to any one of [11] to [15], wherein termites to be controlled using the termite controlling agent composition comprise Coptotermes formosanus Shiraki.

### Effects of Invention

According to the present invention, a highly transmissible termite controlling agent composition having an effect of eradicating or substantially eradicating a colony (nest) of termites due to high transmissibility in all of soil treatment, where the composition is sprayed or mixed into soil, termite trail treatment, where a small amount of powders is blown into termite trails of termites and a baiting system, where a bait formulation (poison bait) is placed in soil can be provided.

Meanwhile, dicloromezotiaz, the active ingredient of the termite controlling composition of the present invention, is a known compound known to have insecticidal activity against lepidopteran pests and the like and is also known to have an effect of controlling termites (for example, see Patent Documents 2 and 3).

The control effect utilizing transmissibility due to the slow-acting property of dicloromezotiaz is not disclosed in any documents.

Accordingly, the effect provided by the termite controlling agent composition according to the present invention is a remarkable effect that cannot be predicted even by those skilled in the art from the prior art.

### BRIEF DESCRIPTION OF DRAWINGS

FIG. 1 A diagram schematically illustrating a test method in Test Example 2.

FIG. 2 A photograph showing a container (bring box) in which the prepared bait formulation is placed and which is used in Test Example 4.

FIG. 3 A schematic diagram illustrating a side surface of an injection molded product (dimension of molded product: 10 mm in diameter×200 mm in height) used to inject an agent in Test Example 6. Each numerical value represents a length, with the unit being millimeters.

FIG. 4 A schematic diagram illustrating, from a side surface side, an installation state of a box-shaped container, an untreated stake and a stick-formed anti-termite agent used in Test Example 6. Each numerical value represented with a straight arrow represents a length, with the unit being millimeters.

### FORMS TO CARRY OUT INVENTION

The highly transmissible termite controlling agent composition of the present invention is characterized by containing, as an active ingredient, dicloromezotiaz that has a non-repellent action against termites, has high insecticidal activity that can halt actions, lead to a moribund state or kill termites with an extremely small effective amount and has an appropriate slow-acting property allowing the effect to be exhibited after termites having contacted the agent return to a nest (colony) and thus having high transmissivity.

In the present specification, the term “high transmission performance” and the term “high transmissivity” mean excellent transmissivity that a composition, a compound or a medium such as soil possesses. In the present specification, the term “high transmission performance” and the term “high transmissivity” mean transmissivity higher than transmissivity of existing termite controlling substances such as imidacloprid.

In the present specification, a “transmission effect” means an effect of a composition or a compound which is transmitted from one termite to other termites so as to provide some negative impact on the other termites.

In addition, in the present specification, “highly transmissive” is a term for a composition or a compound having high transmissivity and means that the composition or the compound has high transmissivity.

In order to efficiently use the highly transmissive termite controlling agent composition of the present invention for soil treatment or termite trail treatment, the composition may generally be used by formulating same at an appropriate ratio together with, for example, an appropriate solid carrier and/or a liquid carrier and, if necessary, with an auxiliary agent and the like in accordance with a commonly used formulation preparation, dissolving, suspending, mixing, subjecting to impregnation, adsorbing or adhering same and making same into an appropriate formulation according to intended use, for example, into an emulsifiable concentrate, a liquid, an aqueous suspension (flowable agent), a rod formulation compressed into a stick form or a chalk form, microcapsules, a bait formulation, a granule, a dust formulation, using a known method.

The object to which the composition for controlling termites of the present invention is applied is not limited as long as it has a tree-based structure. Examples of such an object include woods, houses using woods, wooden non-house buildings, furniture, crafts and arts.

### Formulations

When the highly transmissive termite controlling agent composition of the present invention is used as a liquid, an emulsifiable concentrate or an aqueous suspension, the content of the dicloromezotiaz is preferably 0.005 to 70 parts by weight and more preferably 0.01 to 50 parts by weight, with the amount of each formulation as a whole taken as 100 parts by weight (the same applies hereinafter). These contents may be set as effective amounts.

Meanwhile, a range specified by with the connecting wording “to” in the present specification represents a range including the numerical values before and after the wording “to”.

When the highly transmissive termite controlling agent composition of the present invention is used as a composition for soil treatment or termite trail treatment, the formulation thereof is not particularly limited. Examples of the formulation used in these treatment methods include an emulsifiable concentrate, a liquid, an aqueous suspension, a rod formulation or rodlet compressed into a stick form or a chalk form, microcapsules, a granule and a dust formulation.

When the highly transmissive termite controlling agent composition of the present invention is used in a formulation of a granule, the content of the dicloromezotiaz is preferably 0.005 to 5 parts by weight and more preferably 0.01 to 1 part by weight.

When the highly transmissive termite controlling agent composition of the present invention is used in a formulation of an aqueous suspension, the content of the dicloromezotiaz may be 0.01 to 50 parts by weight and is preferably 5 to 30 parts by weight and more preferably 10 to 25 parts by weight. An aqueous suspension comprising attapulgite is preferable as the aqueous suspension of the present invention from the points of view of at least viscosity and stability of the agent.

When the highly transmissive termite controlling agent composition of the present invention is used in a formulation of a liquid, the content of the dicloromezotiaz may be 0.01 to 50 parts by weight and is preferably 0.1 to 20 parts by weight and more preferably 1 to 10 parts by weight.

When the highly transmissive termite controlling agent composition of the present invention is used in a formulation of a dust formulation, the content of the dicloromezotiaz is preferably 0.05 to 20 parts by weight and more preferably 0.1 to 5 parts by weight. These contents may be set as an effective amount.

The dust formulation of the present invention preferably provides an effect at least equivalent to fipronil (0.5% powder, Termidor Dust, termite exterminating dust formulation sold by former Aventis CropScience Shionogi Co. Ltd., environscience division) or metaflumizone (50% powder, AgriMart Corporation/colony buster) in soil treatment or termite trail treatment.

In order to effectively use the highly transmissive termite controlling agent composition of the present invention in a baiting system, the composition may be prepared as a bait formulation or the like as follows and used: dicloromezotiaz is dissolved in an appropriate liquid carrier and a wood or cellulose base material to prepare a bait formulation is then impregnated with the solution; dicloromezotiaz is mixed with or adhered to wood substrate material powders and the mixture is then molded and solidified; or dicloromezotiaz and cellulose powders are mixed and the mixture is further mixed with a fixing agent or a binder, which is then molded and solidified, for example.

When the highly transmissive termite controlling agent composition of the present invention is used in a formulation of a bait, the content of the dicloromezotiaz is preferably 0.0001 to 20 parts by weight and more preferably 0.001 to 10 parts by weight. These contents may be set as an effective amount.

The solid carrier used in the highly transmissive termite controlling agent composition of the present invention includes, for example, natural minerals such as quartz, clay, kaolinite, pyrophyllite, sericite, talc, bentonite, Fubasami Clay, ceramics, acidic clay, attapulgite, zeolite, colemanite, diatomaceous earth and sulfur;
inorganic salts such as calcium carbonate, ammonium sulfate, sodium sulfate and potassium chloride;
organic solid carriers such as synthetic silicic acids, synthetic silicates, synthetic hydrous silicon oxides, hydrated silica, starch, cellulose and plant powders (e.g. sawdust, coconut husks, corncobs, tobacco stalks, etc.);
plastic carriers such as polyethylene, polypropylene and polyvinylidene chloride;
synthetic resin (polyester resin such as polypropylene, polyacrylonitrile, polymethyl methacrylate and polyethylene terephthalate;
nylon resin such as nylon-6, nylon-11 and nylon-66;
polyamide resin, polyvinyl chloride, polyvinylidene chloride, vinyl chloride-propylene copolymers, etc.); and
urea, inorganic hollow bodies, plastic hollow bodies, activated carbon, fumed silica (white carbon), hydrophobic silica, chemical fertilizers (ammonium sulfate, ammonium phosphate, ammonium nitrate, urea, ammonium chloride and the like), pumice stone, calcite, meerschaum, dolomite, olivine, pyroxene, amphibole, feldspar, alumina, vermiculite, perlite, elastomers, plastics, ceramics, metals, sawdust, wood, corncobs, coconut palm husks, fine powders and granules of tobacco stems. They may be used singly or two or more kinds thereof may be used in combination.

The liquid carrier includes, for example,
alcohols such as monohydric alcohols such as methanol, ethanol, propanol, isopropanol and butanol and polyhydric alcohols such as ethylene glycol, diethylene glycol, propylene glycol, hexylene glycol, polyethylene glycol, polypropylene glycol and glycerin;
polyhydric alcohol compounds such as propylene glycol ether;
ketones such as acetone, methyl ethyl ketone, methyl isobutyl ketone, diisobutyl ketone and cyclohexanone;
ethers such as ethyl ether, dioxane, ethylene glycol monoethyl ether, dipropyl ether and tetrahydrofuran;
aliphatic hydrocarbons such as normal paraffin, naphthene, isoparaffin, kerosene and mineral oil;
aromatic hydrocarbons such as benzene, toluene, xylene, solvent naphtha and alkylnaphthalene;
halogenated hydrocarbons such as dichloromethane, chloroform and carbon tetrachloride;
esters such as ethyl acetate, diisopropyl phthalate, dibutyl phthalate, dioctyl phthalate and dimethyl adipate;
lactones such as γ-butyrolactone;
amides such as dimethylformamide, diethylformamide, dimethylacetamide and N-alkylpyrrolidinone;
nitriles such as acetonitrile;
sulfur compounds such as dimethylsulfoxide;
vegetable oil such as soybean oil, rapeseed oil, cottonseed oil and castor oil; and
water.

They may be used singly or two or more kinds thereof may be used in combination.

Additives used in the highly transmissive termite controlling agent composition of the present invention include a surfactant used as a dispersant, a wetting agent, a spreader, a spreading agent or the like; a binder; a tackifier; a thickening agent; a colorant; a freeze-restoring agent; an anti-caking agent; a disintegrant; a decomposition inhibitor; a pH adjustor; a light stabilizer; and an anti-settling agent. In addition, a preservative, plant pieces or the like may be used as an additive component, if necessary.

They may be used singly or two or more kinds thereof may be used in combination.

The surfactant suitably used in the highly transmissive termite controlling agent composition of the present invention can be any surfactant known in the art. The surfactant used as a dispersant, a wetting agent, a spreader, a spreading agent or the like include, for example, a vegetable oil-based nonionic surfactant, an alcohol-based nonionic surfactant, a polyoxyethylene-polyoxypropylene block polymer-based nonionic surfactant, an alkylphenol-based nonionic surfactant, a sugar ester-based nonionic surfactant, a fatty acid ester-based nonionic surfactant, a bisphenol-based nonionic surfactant, a polyaromatic ring-based nonionic surfactant, a silicone-based nonionic surfactant and a fluorine-based nonionic surfactant.

Examples of the vegetable oil-based nonionic surfactant include hardened castor oil, polyoxyalkylene castor oil (such as polyoxyethylene castor oil) and polyoxyalkylene hardened castor oil (such as polyoxyethylene hardened castor oil). Examples of the alcohol-based nonionic surfactant include a polyoxyethylene alkyl ether, a polyoxyethylene alkyl aryl ether, a poly(ethylene glycol-ran-propylene glycol) monobutyl ether, acetylene diol and a polyoxyalkylene-added acetylene diol.

The polyoxyethylene-polyoxypropylene block polymer-based nonionic surfactant includes, for example, a polyoxyethylene-polyoxypropylene block polymer, a polystyrene-polyoxyethylene block polymer, an alkylpolyoxyethylene-polyoxypropylene block polymer ether, a polyoxyethylene alkylamine and an alkylphenylpolyoxyethylene-polyoxypropylene block polymer ether.

The alkylphenol-based nonionic surfactant includes, for example, a polyoxyethylene alkylphenyl ether, a polyoxyethylene dialkylphenyl ether, a polyoxyalkylene benzylphenyl ether, a polyoxyalkylene styrylphenyl ether and a polyoxyethylene alkylphenyl ether-formalin condensate.

The sugar ester-based nonionic surfactant includes, for example, a polyoxyethylene sorbitan fatty acid ester, a polyoxyalkylene sorbitol fatty acid ester (for example, a polyoxyethylene sorbitol fatty acid ester), a glycerin fatty acid ester, a polyoxyethylene fatty acid amide and a sucrose fatty acid ester.

The fatty acid ester-based nonionic surfactant includes, for example, a sorbitan fatty acid ester, a polyoxyethylene fatty acid ester, a polyoxyethylene resin acid ester and a polyoxyethylene fatty acid diester.

The bisphenol-based nonionic surfactant includes, for example, a polyoxybisphenyl ether and a polyoxyethylene fatty acid bisphenyl ether.

The polyaromatic ring-based nonionic surfactant includes, for example, a polyoxyalkylene benzylphenyl ether and a polyoxyalkylene styrylphenyl ether.

The silicon-based nonionic surfactant includes, for example, a polyoxyethylene ether-type silicon-based surfactant and a polyoxyethylene ester-type silicon-based surfactant.

Anionic surfactants include, for example, a sulfate-type anionic surfactant, a sulfonate-type anionic surfactant, a phosphate-type anionic surfactant and a carboxylic acid-type anionic surfactant.

The sulfate-type anionic surfactant includes, for example, an alkyl sulfate, a polyoxyethylene alkyl ether sulfate, a polyoxyethylene alkyl phenyl ether sulfate, a polyoxyethylene styryl phenyl ether sulfate, an alkyl benzene sulfonate, an alkyl aryl sulfonate, a lignin sulfonate, an alkyl sulfosuccinate, a naphthalene sulfonate, an alkyl naphthalene sulfonate, a formalin condensate salt of naphthalene sulfonic acid and a polyoxyethylene-polyoxypropylene block polymer sulfate.

The sulfonate-type anionic surfactant can include, for example, a paraffin sulfonate, a dialkyl sulfosuccinate, an alkylbenzene sulfonate, a monoalkylnaphthalene sulfonate, a dialkylnaphthalene sulfonate, a formalin condensate salt of an alkylnaphthalene sulfonic acid and an alkyldiphenyl ether disulfonate.

The phosphate-type anionic surfactant includes, for example, a polyoxyethylene alkyl ether phosphate, a polyoxyethylene alkyl phenyl ether phosphate, a polyoxyethylene dialkyl phenyl ether phosphate, a polyoxyethylene styryl phenyl ether phosphate, a polyoxyethylene-polyoxypropylene block polymer phosphate and an alkyl phosphate.

The carboxylic acid-type anionic surfactant includes, for example, fatty acid salts such as a fatty acid sodium salt, a fatty acid potassium salt and a fatty acid ammonium salt, polycarboxylic acid salts, polyacrylic acid salts, N-methyl-fatty acid sarcosinates and resin acid salts such as a resin acid sodium salt and a resin acid potassium salt.

Cationic surfactants include, for example, an alkylamine salt, an ammonium-type cationic surfactant and a benzalkonium-type cationic surfactant.

The alkylamine salt includes, for example, laurylamine hydrochloride, stearylamine hydrochloride, oleylamine hydrochloride, stearylamine acetate, stearylaminopropylamine acetate, an alkyltrimethylammonium chloride and an alkyldimethylbenzalkonium chloride.

The ammonium-type cationic surfactant includes, for example, a methyl polyoxyethylene alkyl ammonium chloride, an alkyl N-methylpyridinium bromide, a mono- or dialkylmethylated ammonium chloride and an alkylpentamethylpropylenediamine chloride.

The benzalkonium-type cationic surfactant includes, for example, an alkyldimethylbenzalkonium chloride, benzethonium chloride and octylphenoxyethoxyethyl dimethylbenzyl ammonium chloride.

Examples of an amphoteric surfactant can include amino acid-type and betaine-type amphoteric surfactants.

The betaine-type amphoteric surfactant includes dialkyl diamino ethyl betaine, alkyl dimethyl benzyl betaine, alkyl dimethyl amino acetic acid betaine, coconut oil fatty acid amidopropyl betaine and octanoic acid amidopropyl betaine. The amino acid-type amphoteric surfactant includes an alkyldimethylamine oxide.

One kind of these surfactants may be used singly or two or more kinds thereof may be used in combination.

The fixing agent, dispersant, thickening agent, binder and anti-settling agent include casein, carboxymethyl cellulose or a salt thereof, dextrin, water-soluble starch, xanthan gum, guar gum, sucrose, polyvinylpyrrolidone, gum arabic, polyvinyl alcohol, polyethylene glycol, gelatin, alginic acid, xanthan gum, polyvinyl acetate, sodium polyacrylate and polyethylene glycol having an average molecular weight of 6,000 to 20,000, polyethylene oxide having an average molecular weight of 100,000 to 5,000,000, phospholipid (e.g., cephalin, lecithin, etc.), cellulose powder, dextrin, modified starch, a polyaminocarboxylic acid chelate compound, crosslinked polyvinylpyrrolidone, a copolymer of maleic acid and styrene, a (meth)acrylic acid-based copolymer, a half-ester of a polymer composed of a polyhydric alcohol and a dicarboxylic anhydride, a water-soluble salt of polystyrenesulfonic acid, paraffin, a terpene, a polyamide resin, a polyacrylate, a polyoxy ethylene, wax, a polyvinyl alkyl ether, an alkylphenol formalin condensate, synthetic resin emulsion and attapulgite.

Attapulgite functions as a thickening agent and/or an anti-settling agent in aqueous suspension in addition to the function as the solid carrier.

They may be used singly or two or more kinds thereof may be used in combination.

When the highly transmissive termite controlling agent composition of the present invention is used in a bait formulation, materials that can be used as a food ingredient and/or an attractant ingredient include, for example, monosaccharides such as glucose and xylose;
disaccharides such as sucrose and lactose;
polysaccharides such as cellulose, starch and dextrin;
amino acids, proteins, fragrances (including synthetic fragrances, natural fragrances or blends thereof);
wood materials (for example, coniferous trees such as Pinus densiflora, Pinus thunbergii and Tsuga sieboldii, broad-leaf trees such as Betula and Carya illinoinensis and bagasse);
cellulose derivatives (cellulose ethers such as methylcellulose, hydroxypropyl cellulose, hydroxypropyl methylcellulose, carboxymethylcellulose and a sodium salt of carboxymethylcellulose or alkali metal salts thereof); and
plant extracts, animal extracts and trail pheromones.

They may be used singly or two or more kinds thereof may be used in combination. In particular, wood materials, cellulose and cellulose derivatives are preferable.

A powder containing cellulose as a main component includes cellulose powder, sawdust, wood flour. In the case of wood flour, the species of trees are preferably those preferred by termites and; tree species such as cherry, Aucuba, pine, spruce and cedar are preferable, for example.

As the fixing agent for solidifying the powders containing cellulose as a main component, an artificially synthesized fixing agent such as Machilus thunbergii powder, starch powder, glutinous rice, a vinyl acetate emulsion-based fixing agent, a synthetic rubber-based fixing agent, an epoxy resin-based fixing agent, a cyanoacrylate-based fixing agent or a vinyl chloride-based fixing agent can be used; it is preferable to use Machilus thunbergii powder, starch powders or glutinous rice. The blending amount of the fixing agent is desirably 20 parts by weight or more and 60 parts by weight or less based on 100 parts by weight of the powders containing cellulose as a main component.

### Treatment Method

The highly transmissive termite controlling agent composition of the present invention can be used in soil treatment, where the composition is sprayed or mixed into soil, termite trail treatment, where a small amount of powders is blown into termite trails of termites and a baiting system, where a bait formulation (a poison bait) is placed in soil.

The “soil treatment” in the present invention refers to, for example, spray treatment of soil below a floor or soil around the outer periphery of a building foundation using a spray gun; soil injection treatment where an agent solution is sent into a nozzle inserted into soil at a high pressure; drug treatment by inserting, into soil, an anti-termite agent (such as a PIM agent/Pulp Injection Molding agent) which is a rod formulation compressed into a stick form using pulp or the like; and mixing treatment where excavated soil is mixed with a drug and then backfilled.

The composition and shape of the highly transmissive termite controlling agent composition used in the soil treatment of the present invention are not limited and examples thereof include those obtained by injection-molding a liquid obtained by adding dicloromezotiaz and water to a molding material containing pulp and cellulose fibers and starch. In particular, a rod formulation is preferable.

The size of the rod formulation of the present invention is not limited and examples thereof include an outer diameter of about 8 mm to 12 mm and a length (height) of about 180 mm to 220 mm.

The content of dicloromezotiaz in the rod formulation of the present invention is also not limited and is about 2.0% by weight to about 4.0% by weight, for example.

The number of rods to be installed and the installation method of the rod formulation of the present invention are not limited and the rods may be installed by, for example, driving the rods at intervals of about 25 cm to about 35 cm around a target area that needs to be subjected to termite control. The termite controlling agent composition consisting of the rod formulation (stick-formed anti-termite agent) of the present invention preferably exhibits a control effect against termites such as Coptotermes formosanus Shiraki within about one year. More preferably, the termite controlling agent composition consisting of the rod formulation (stick-formed anti-termite agent) of the present invention exhibits a control effect against termites such as Coptotermes formosanus Shiraki within about one year and maintains the control effect for about two years or longer thereafter.

The “termite trail treatment” in the present invention is a treatment method in which a small amount of powders is blown into termite trails of termites with an agent in an appropriate formulation, as described above. A termite trail is a tunnel-like passage made by termites piling up soil to block out dry air above ground and sunlight. In the termite trail treatment in the present invention, a treatment method in which a dust formulation or the like are blown and injected through a hole made in part of the termite tube using an atomizer and the like may be used. As the termite trail treatment in the present invention, a method in which a dust formulation containing about 0.5% by weight to about 1% by weight of dicloromezotiaz is injected at a rate of about 1 g per spot and about 10 g to about 15 g per site is preferable.

The highly transmissive termite controlling agent composition of the present invention can also be used in methods of administering the composition to a termite habitat, a damage site, an underground area and the inside of wood. Examples of such administration methods include a method of investigating termites inside a building using an existing termite detector, drilling a hole in an area where termites are residing or in a damaged area and administering the termite controlling composition into the hole to control termites. The diameter of the hole in opening the hole is desirably about 20 mm or less. In addition, even when termites are not currently present, if there is a potential for future infestation in a building, the termite controlling composition of the present invention can be buried at intervals of about 10 cm to about 5 m, preferably about 30 cm to about 3 m, in soil surrounding the building and/or in soil below the floor thereof to preventively control termites.

Furthermore, a wood component susceptible to termite damage can be preliminarily drilled at intervals of about 3 cm to about 2 m, preferably about 5 cm to about 30 cm, using an electric drill or the like and the termite controlling composition can be administered thereinto to preventively control termites.

The treatment amount of the composition for controlling termites of the present invention in the method of the present invention is not limited as long as a desired effect is exhibited. Such a treatment amount is, for example, 0.001 to 100 g/m² and preferably 0.001 to 10 g/m² in terms of the amount of dicloromezotiaz.

The “baiting system” herein refers to a procedure method involving burying or placing, in soil wood impregnated with an agent or a molded and solidified product of a wood base material or cellulose base material with which an agent is mixed or to which an agent is attached.

In the “baiting system” in the present invention, an agent may be put in an arbitrary container and the container may be placed. An example of such a container is a bring box.

As the baiting system in the present invention, a method of using a bait formulation comprising about 10 ppm to about 100 ppm of dicloromezotiaz is preferable.

The “wood” described herein is not particularly limited as long as it is wood that can be damaged (eaten) by termites and includes various kinds of unprocessed wood, processed wood and the like.

The wood include unprocessed trees, architectural wood and elements, various final wood products (logs and materials such as boards, planks and laths, flat plates, siding panels, square logs, large surface area elements such as wall elements, furniture, boxes, pallets, containers, cases, outdoor furniture and other wood products), imported and exported wood, wood materials for sawing, wooden beams, wooden vehicles, outdoor stationary structures (wooden buildings, wooden balconies, telephone line utility poles, wooden fences, racks, poles, wooden bars, components of bridges, piers and the like, jetties, railway ties, boat docks), wooden windows and doors, household construction, joinery and wood products used in the wood working and joinery industries, wood-containing materials such as wood products or wood/plastic composites (WPC: thermoplastically processable composite material composed of wood, plastic and an additive), plywood, chipboard, fiberboard oriented strand board (OSB), composite boards and diatomaceous earth panels.

The highly transmissive termite controlling agent composition of the present invention is suitable for controlling termites and has remarkable transmission performance allowing eradication of a nest (colony) of all termites damaging houses, wood, wooden buildings, such as Reticulitermes amamianus, Incisitermes minor, Coptotermes formosanus Shiraki, Hodotermopsis japonica, Glyptotermes fuscus, Reticulitermes sp., Reticulitermes flaviceps amamianus, Glyptotermes kushimensis, Coptotermes guangzhoensis, Neotermes koshunensis, Glyptotermes kodamai, Glyptotermes satsumensis, Hodotermitidae, Cryptotermes domesticus (Haviland), Odontotermes formosanus (Shiraki), Nasutitermes takasagoensis, Glyptotermes nakajimai, Pericapritermes nitobei, Reticulitermes miyatakei, Sinocapritermes mushae, Reticulitermes speratus (Kolbe), Reticulitermes flavipes, Reticulitermes hesperus, Reticulitermes virginicus, Reticulitermes tibialis, Heterotermes aureus and Zootermopsis nevadensis, for example.

The termite controlling agent composition of the present invention preferably exhibits at least the same effect in controlling termites as compared to a composition comprising a compound used in a neonicotinoid termite controlling agent. Examples of compounds used in the neonicotinoid termite controlling agent include imidacloprid, clothianidin, dinotefuran and thiamethoxam.

In addition, the termite controlling agent composition of the present invention preferably exhibits at least the same effect in controlling termites as compared to a slow-acting termite controlling agent. Examples of compounds used in the slow-acting termite controlling agent include fipronil, chlorantraniliprole, chlorfenapyr and broflanilide.

### EXAMPLES

Hereinafter, representative examples and test examples of the present invention will be described. However, the present invention is not limited thereto. Meanwhile, in the examples, “parts” mean “parts by weight (% W/W)”. In addition, the preparation method of the agent-treated soil in the test examples was conducted in accordance with the method for preparing treated-soil for tests in the standard of the public interest incorporated association, Japan Wood Protection Association, JWPA-TS-(1) (2018) “performance criteria for anti-termite agents and the like for soil treatment and test methods for same.”

### Formulation Example 1

To 67.3 parts of water were added 3.0 parts of an acrylic acid copolymer, 2.0 parts of poly(ethylene glycol-ran-propylene glycol)monobutyl ether, 6.8 parts of propylene glycol, 0.5 parts of dimethylpolysiloxane and 0.2 parts of 1,2-benzoisothiazolin-3-one. The mixture was mixed and dissolved using a stirrer and 19.0 parts of dicloromezotiaz was then added thereto and dispersed, followed by fine pulverization with a wet pulverizer to obtain a pulverized product having an average particle diameter of 1.0 μm. To the pulverized product, were added 0.2 parts of xanthan gum and 1.0 parts of attapulgite and the mixture was uniformly mixed to obtain an aqueous suspension composition (aqueous suspension).

### Test Example 1: Test of Effect of Agent Against Coptotermes formosanus Shiraki

A test agent solution containing 0.023 parts of dicloromezotiaz was prepared by adding 99.875 parts of water to 0.125 parts of the aqueous suspension composition shown in Formulation Example 1.

In a comparative example, an aqueous suspension composition prepared by adding an agent solution, wherein 99 parts of water was added to 1 part of a flowable containing 10.0 parts of imidacloprid and which contained 0.1 parts of imidacloprid and a drug solution, wherein 299 parts of water was added to 1 part of a flowable containing 9.1 parts of fipronil and which contained 0.03 parts of fipronil, uniformly mixing same was used as a test agent solution of a comparative example.

As the imidacloprid formulation and the fipronil formulation, commercially available termite controlling agents were used and diluted solutions at practical agent concentrations thereof were used as test agent solutions.

Gypsum was cured and spread in a glass petri dish having a diameter of 90 mm, 15 ml of each of the test agent solution of the example and the test agent solution of the comparative example was uniformly dropped on the entire surface of the gypsum. Thereafter, ten workers of Coptotermes formosanus Shiraki were released into the petri dish and the petri dish was covered and left to stand in a thermostatic chamber (25° C./relative humidity 60%).

The number of abnormal termites and the number of dead termites among the released termites (Coptotermes formosanus Shiraki) were observed every one hour from immediately after the release of the termites (Coptotermes formosanus Shiraki) until ten hours passed and the total number of the abnormal termite rate and the dead termite rate was calculated as the abnormal or dead termite rate (%) according to [Expression 1] below and the rates of expression of the effects of the respective agents were compared. Each test agent was prepared in one petri dish as one plot and the test was carried out in two replicates. The results are shown in Table 1.

$$Abnormal or dead termite rate ( \% ) = ( number of abnormal termites + number of dead termites ) \times 100 / number of tested termites$$

TABLE 1

| | | Abnormal or dead termite rate (%) | | | | | | | | | |
|---|---|---|---|---|---|---|---|---|---|---|---|
| | Time elapsed (h) | 1 | 2 | 3 | 4 | 5 | 6 | 7 | 8 | 9 | 10 |
| Example | Dicloromezotiaz (0.023%) | 0 | 0 | 0 | 0 | 0 | 19 | 37 | 51 | 78 | 100 |
| Comparative | Imidacloprid (0.1%) | 100 | 100 | 100 | 100 | 100 | 100 | 100 | 100 | 100 | 100 |
| example | Fipronil (0.03%) | 18 | 36 | 52 | 100 | 100 | 100 | 100 | 100 | 100 | 100 |

### Test Example 2: Test of Effect of Transmission Treatment Against Coptotermes formosanus Shiraki

A test agent solution containing 0.023 parts of dicloromezotiaz was prepared by adding 99.875 parts of water to 0.125 parts of the aqueous suspension composition shown in Formulation Example 1. As comparative examples, four types of commercially available neonicotinoid termite controlling agents and four types of slow-acting termite controlling agents shown in Table 2 were diluted with water at practical concentrations to prepare test agent solutions. The “agent concentration (%)” indicates the concentration of the active ingredient contained in each of the composition of the present invention and the termite controlling agents and the “test agent solution concentration (%)” indicates the concentration of the active ingredient in each of the prepared test agent solutions.

After 1.2 g of each of the test agent solutions of the example and the comparative examples diluted to a predetermined concentration and prepared was added to 4.8 g of soil, 6 g of the mixed soil was spread in a glass petri dish having a diameter of 50 mm and ten workers of Coptotermes formosanus Shiraki were released into the petri dish and exposed to the agent solution for 4 hours. Thereafter, three out of the ten worker termites (Coptotermes formosanus Shiraki) brought into contact with and exposed to the agent were transferred into a petri dish which had a diameter of 50 mm, was lined with filter paper, which contained 30 untreated worker termites (Coptotermes formosanus Shiraki) for primary transmission treatment and abnormal/dead termite rates after 1 day, 3 days, 7 days, 14 days and 21 days were then observed in comparison with untreated termites to investigate the primary transmission effect. Further, after 24 hours following the primary transmission treatment, three of the 30 worker termites (Coptotermes formosanus Shiraki) subjected to the primary transmission were transferred to a separate petri dish which had a diameter of 50 mm, was lined with filter paper, which contained 30 untreated worker termites (Coptotermes formosanus Shiraki) for secondary transmission treatment and abnormal/dead termite rates after 1 day, 3 days, 7 days, 14 days and 21 days were then observed in comparison with untreated termites to investigate the secondary transmission effect.

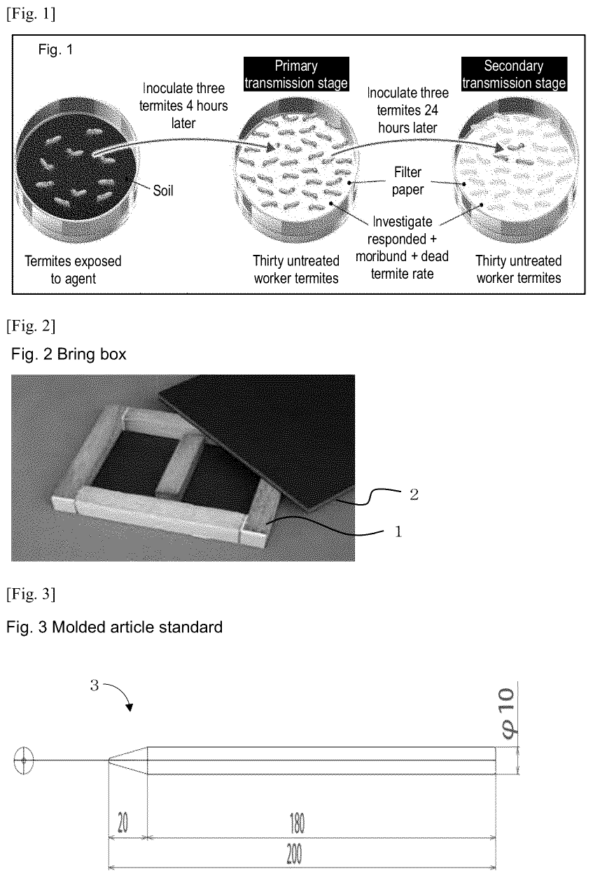

The test method is shown in FIG. 1, the results of the primary transmission treatment are shown in Tables 3 and 4 and the results of the secondary transmission treatment are shown in Tables 5 and 6.

TABLE 2

| | | | Test agent |
|---|---|---|---|
| | | Drug | solution |
| | Active | concentra- | concentra- |
| | ingredient | tion (%) | tion (%) |
| Example | Dicloromezotiaz | 19.0 | 0.023 |
| Comparative example 1 | Fipronil | 3.0 | 0.030 |
| Comparative example 2 | Imidacloprid | 10.0 | 0.100 |
| Comparative example 3 | Chlorantraniliprole | 18.4 | 0.050 |
| Comparative example 4 | Chlorfenapyr | 21.0 | 0.110 |
| Comparative example 5 | Clothianidin | 10.0 | 0.050 |
| Comparative example 6 | Dinotefuran | 20.0 | 0.200 |
| Comparative example 7 | Thiamethoxam | 20.0 | 0.100 |
| Comparative example 8 | Broflanilide | 12.0 | 0.030 |

TABLE 3

| | | Test agent | Abnormal or dead termite rate (%) | | | | |
|---|---|---|---|---|---|---|---|
| | | solution | After | After | After | After | After |
| | Active ingredient | concentration | 1 day | 3 days | 7 days | 14 days | 21 days |
| Example | Dicloromezotiaz | 0.023% | 100 | 100 | 100 | 100 | 100 |
| Comparative example 1 | Fipronil | 0.03% | 82 | 95 | 100 | 100 | 100 |
| Comparative example 2 | Imidacloprid | 0.10% | 92 | 22 | 11 | 14 | 15 |
| Comparative example 3 | Chlorantraniliprole | 0.05% | 98 | 100 | 85 | 80 | 85 |
| Untreated | — | — | 3.3 | 1.2 | 1.2 | 2.5 | 2.5 |

TABLE 4

| | | Test agent | Abnormal or dead termite rate (%) | | | | |
|---|---|---|---|---|---|---|---|
| | Active | solution | After | After | After | After | After |
| | ingredient | concentration | 1 day | 3 days | 7 days | 14 days | 21 days |
| Example | Dicloromezotiaz | 0.023% | 100 | 100 | 100 | 100 | 100 |
| Comparative example 4 | Chlorfenapyr | 0.11% | 89 | 80 | 89 | 100 | 100 |
| Comparative example 5 | Clothianidin | 0.05% | 94 | 89 | 75 | 91 | 94 |
| Comparative example 6 | Dinotefuran | 0.20% | 93 | 94 | 96 | 98 | 99 |
| Comparative example 7 | Thiamethoxam | 0.10% | 98 | 91 | 98 | 95 | 96 |
| Comparative example 8 | Broflanilide | 0.03% | 100 | 73 | 48 | 53 | 56 |
| Untreated | — | — | 0 | 0 | 0 | 1.2 | 1.2 |

TABLE 5

| | | Test agent | Abnormal or dead termite rate (%) | | | | |
|---|---|---|---|---|---|---|---|
| | Active | solution | After | After | After | After | After |
| | ingredient | concentration | 1 day | 3 days | 7 days | 14 days | 21 days |
| Example | Dicloromezotiaz | 0.023% | 8.9 | 83 | 91 | 91 | 92 |
| Comparative example 1 | Fipronil | 0.03% | 0 | 0 | 19 | 30 | 31 |
| Comparative example 2 | Imidacloprid | 0.10% | 0 | 1.1 | 1.1 | 1.1 | 1.2 |
| Comparative example 3 | Chlorantraniliprole | 0.05% | 10 | 2.2 | 1.1 | 2.2 | 7.8 |
| Untreated | — | — | 3.3 | 1.2 | 1.2 | 2.5 | 2.5 |

TABLE 6

| | | Test agent | Abnormal or dead termite rate (%) | | | | |
|---|---|---|---|---|---|---|---|
| | Active | solution | After | After | After | After | After |
| | ingredient | concentration | 1 day | 3 days | 7 days | 14 days | 21 days |
| Example | Dicloromezotiaz | 0.023% | 2.2 | 44 | 88 | 88 | 84 |
| Comparative example 4 | Chlorfenapyr | 0.11% | 0 | 0 | 3.3 | 7.8 | 31 |
| Comparative example 5 | Clothianidin | 0.05% | 0 | 0 | 3.3 | 3.3 | 4.4 |
| Comparative example 6 | Dinotefuran | 0.20% | 24 | 18 | 16 | 18 | 22 |
| Comparative example 7 | Thiamethoxam | 0.10% | 0 | 0 | 3.3 | 3.3 | 4.4 |
| Comparative example 8 | Broflanilide | 0.03% | 2.2 | 0 | 3.3 | 5.6 | 6.7 |
| Untreated | — | — | 0 | 0 | 0 | 2.2 | 3.3 |

As shown in Tables 3 to 6, it has been revealed that the termite controlling agent composition of the present invention has primary transmissibility and secondary transmissibility processing property exceeding those of the conventional agents.

### Test Example 3: Extirpation Test (Transmission Treatment Effect Test) with a Dust Formulation Against Coptotermes formosanus Shiraki Using Simulated Termite Trails

Into a petri dish, 50 mg of each powder composed of 0.5% by weight of dicloromezotiaz, 96.5% by weight of polyethylene and 3.0% by weight of hydrophobic silica was thinly spread. Twenty worker termites (Coptotermes formosanus Shiraki) were put into the petri dish and brought into contact with the agent for 10 minutes. The worker termites (Coptotermes formosanus Shiraki) having been exposed to the agent were transferred to a test plot in which 5 g of mountain soil from a Kagoshima field test site was wetted with 1 ml of distilled water. The termites (Coptotermes formosanus Shiraki) were observed over time to investigate the rate of Abnormal or dead termites (Abnormal or dead termite rate).

As comparative examples, similarly to each of the above-described tests, the secondary transmission effect was investigated using fipronil (0.5% dust formulation, Termidor Dust, termite exterminating dust formulation sold by former Aventis CropScience Shionogi Co. Ltd., environscience division) and metaflumizone (50% dust formulation, AgriMart Corporation/colony buster) as control agents and a powder substrate material (without an active ingredient) as an untreated control, taking Abnormal or dead termite rates (%) as indexes. The results are shown in Table 7.

TABLE 7
Active ingredient Concentration

| Active | Concentration | Abnormal or dead termite rate (%) | | | | | | | | | | |
|---|---|---|---|---|---|---|---|---|---|---|---|---|
| ingredient | (%) | 1 h | 2 h | 3 h | 4 h | 5 h | 6 h | 7 h | 1 day | 2 days | 3 days | 7 days |
| Dicloromezotiaz | 1 | 0 | 30 | 85 | 85 | 100 | 100 | 100 | 100 | 100 | 100 | 100 |
| | 0.5 | 0 | 0 | 45 | 45 | 100 | 100 | 100 | 100 | 100 | 100 | 100 |
| | 0.25 | 0 | 0 | 25 | 25 | 60 | 100 | 100 | 100 | 100 | 100 | 100 |
| | 0.10 | 0 | 0 | 0 | 25 | 35 | 40 | 40 | 85 | 100 | 100 | 100 |
| Metaflumizone | 50 | 0 | 0 | 0 | 0 | 0 | 0 | 0 | 100 | 100 | 100 | 100 |
| Fipronil | 0.5 | 0 | 5 | 50 | 95 | 95 | 100 | 100 | 100 | 100 | 100 | 100 |

As shown in Table 7, it has been revealed that the termite controlling agent composition of the present invention can provide a termite control effect also through treatment of termite trails.

### Test Example 4: Practical Test in Houses and Buildings in which Damages and Activities of Termites (Coptotermes formosanus Shiraki) had been Confirmed in Habitat Area Thereof in Kansai Region and to West of Kansai Region

The effects were confirmed in houses and buildings in which damages and activities of termites (Coptotermes formosanus Shiraki) had been confirmed in prefectural habitat areas thereof in the Kansai region and to the west of the Kansai region shown in Table 8. Agent application method: a dicloromezotiaz dust formulation composed of the same formulation as that of the dicloromezotiaz dust formulation used in Test Example 3 was injected into termite trails observed in the test site and a portion of a damaged area in which activities of termites were confirmed. In the case of the termite trails, a part thereof was broken and the formulation was injected therefrom. In the case of the damaged area, the damaged area was pierced and the formulation was injected therefrom. The injection amount was about 1 g per portion and about 10 to 15 g per site (the amount was increased or decreased according to the number of termite trails per site and the situation of the damaged area).

After two to three weeks from application of the agent, an initial investigation was carried out and the effect was confirmed by observing the termite trails and the damaged area (presence or absence of living termites and presence or absence of dead termites). The results are shown in Table 8.

TABLE 8
Termite (Coptotermes formosanus Shiraki) extermination treatment
effectiveness test using dicloromezotiaz dust formulation

| Site | Test location | Test result | Remarks |
|---|---|---|---|
| 1 | Fukuoka prefecture | Confirm good effect | |
| 2 | Saga prefecture | Confirm good effect | |
| 3 | Kumamoto prefecture | Confirm good effect | |
| 4 | Hiroshima prefecture | Confirm great effect | Observe |
| | | | exterminate |
| | | | of attic/nest |
| 5 | Okayama prefecture | Confirm great effect | Observe carcass |
| | | | head |

As shown in Table 8, it was confirmed that the termite controlling agent composition (powder formulation) of the present invention could exhibit a control effect on termites also in the site at which termites infested.

### Test Example 5: Termites (Coptotermes formosanus Shiraki) Extermination Field Test Using a Bait Formulation Containing Dicloromezotiaz

In a PP bag, 198 g of powdery cellulose (KC-200Y manufactured by Nippon Paper Industries Co., Ltd.) and 2 g of a dicloromezotiaz pharmaceutical ingredient were mixed and shaken to obtain 10,000 ppm raw powder. Based on the raw powder, 10-fold dilution was repeated in the same operation to achieve concentrations of 1,000 ppm, 100 ppm and 10 ppm so as to obtain a bait formulation having a predetermined concentration.

In the same manner as in Test Example 4, the effects were confirmed in houses and buildings in which damages and activities of termites (Coptotermes formosanus Shiraki) had been confirmed in habitat areas thereof in the Kansai region and to the west of the Kansai region by a baiting system in which the prepared bait formulation was placed in the installation method shown in FIG. 2 below, that is, a method in which a predetermined amount of the bait was placed and installed in a bring box (manufactured by HIROSE Industry Company) made of a wood frame or the like as a container. The results are shown in Table 9.

TABLE 9
Termite (Coptotermes formosanus Shiraki) extermination
treatment effectiveness test using the bait
formulation containing dicloromezotiaz

| | | Installation | Dicloro- | |
|---|---|---|---|---|
| | Test | method | mezotiaz | |
| No. | location | (container) | (ppm) | Evaluation (result) |
| Site 1 | Kumamoto | Bring box | 10 | Succeed in extermination |
| Site 2 | Kumamoto | Bring box | 10 | Succeed in extermination |
| Site 3 | Kumamoto | Bring box | 10 | Succeed in extermination |

As shown in Table 9, it was confirmed that the termite controlling agent composition of the present invention could exhibit a control effect on termites also in a bait formulation and also in the site at which termites infested.

### Test Example 6: Termites (Coptotermes formosanus Shiraki) Extermination Field Test Using Stick-Formed Anti-Termite Agent PIM Containing Dicloromezotiaz

Using a pulp injection molding PIM technique (Pulp Injection Molding/DAIHO INDUSTRIAL Co., Ltd., KANSAI Company), 2.5% of dicloromezotiaz and 7.0% of water were added to 90.5% of a molding material containing pulp (and cellulose fiber KC FLOCK 400; Nippon Paper Industries Co., Ltd.) and starch as main components and the mixture was injected (molded body dimension: 10 mm in diameter and 200 in height, see FIG. 3) through injection molding and a stick-formed anti-termite agent 3 thus obtained was used for agent treatment.

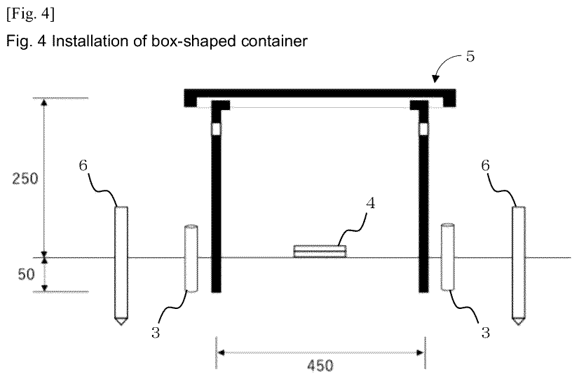

At the test site (Takahashigata National Forest in Minamisatsuma city, Kagoshima prefecture, termite test site/habitat of Coptotermes formosanus Shiraki, where nesting was confirmed in the field), 10 points were marked within the habitat of Coptotermes formosanus Shiraki, where five points were randomly assigned as treated soli plots and the remaining five points were assigned as untreated soli plots. Each of the soil plots was separated from one another by at least one meter. Weeds and fallen leaves were removed from the test site and the ground was leveled. Termite controlling stakes (the stick-formed anti-termite agent 3 described above) to be tested were driven around the outer periphery of test containers in the treated plots at 30 cm intervals. In the center portion of both the treated soil and the untreated soil, two pieces of sound red pine sapwood 4 (100×100×10 mm thick) were stacked and placed. A box-shaped container 5 (450×450×300 mm high) made of vinyl chloride resin was prepared and holes were formed on the upper surface of the box-shaped container at positions where water did not splash onto the holes, so as to prevent the temperature inside the box-shaped container from excessively increasing. The bottom 50 mm of the box-shaped container was buried in the soil. Furthermore, two to four untreated stakes 6 were driven around the container (see FIG. 4). This test was conducted from October 2019 to October 2021. The results are shown in Table 10.

TABLE 10
Termites (Coptotermes formosanus Shiraki) extermination
treatment effectiveness test using stick-formed
dicloromezotiaz anti-termite agent

| Treated | Presence or absence of damage | | |
|---|---|---|---|
| Plot | of wood piece | | |
| number | Year one | Year two | Remarks |
| 1 | None | None | The wood pieces in the |
| 2 | None | None | untreated plots and the |
| 3 | None | None | untreated stakes embedded |
| 4 | None | None | around the test plots |
| 5 | None | None | suffered severe damage. |

The results in Table 10 ave revealed that the termite controlling agent composition of the present invention exhibited an extermination effect on termites (Coptotermes formosanus Shiraki) using a stick-formed anti-termite agent, in particular, a pulp injection molded PIM within at least one year and the effect lasted for at least two years.

Such an effect of controlling termites which is exerted early and then lasts for a long period of time is a significantly remarkable effect which is not found in conventional termite controlling agents.

The control effect of the composition containing dicloromezotiaz as an active ingredient was significantly recognized for the termite (Coptotermes formosanus Shiraki) control effect through transmission, compared to the existing agents in the comparative examples, because of the slow-acting effect thereof.

### INDUSTRIAL APPLICABILITY

The present invention can provide a termite controlling agent composition or a termite controlling agent that have superior transmission performance compared to existing agents required for eradicating termite nests (colonies) by using, as an active ingredient, dicloromezotiaz, which has a non-repellent action and a moderate slow-acting property with extremely high insecticidal activity against Coptotermes formosanus Shiraki.

### EXPLANATION OF SYMBOLS

1 Wood frame
2 Polypropylene plate
3 Stick-formed anti-termite agent
4 Untreated red pine plate
5 Vinyl chloride resin box-shaped container
6 Untreated stake

1. A composition for controlling termites, comprising:
an effective amount of dicloromezotiaz to create a termite-killing transfer effect, the composition for controlling termites being useful for:
transmitting the termite-killing effect of the dicloromezotiaz from one termite to another termite; and
controlling the termites with the termite-killing effect.

2. The termite controlling agent composition according to claim 1, wherein the termite controlling agent composition is in a formulation of any of a liquid, an emulsifiable concentrate, an aqueous suspension, a rod formulation compressed into a stick form or a chalk form, microcapsules, a dust formulation, a granule, and a bait formulation.

3. The termite controlling agent composition according to claim 2, wherein the formulation is any of a liquid, an emulsifiable concentrate, and an aqueous suspension.

4. The termite controlling agent composition according to claim 2, wherein the formulation is the liquid, the emulsifiable concentrate, or the aqueous suspension, and wherein the termite controlling agent composition contains 0.01 to 50 parts by weight of the dicloromezotiaz.

5. The termite controlling agent composition according to claim 2, wherein the formulation is the granule.

6. The termite controlling agent composition according to claim 2, wherein the formulation is the granule and the termite controlling agent composition contains 0.01 to 1 part by weight of the dicloromezotiaz based on 100 parts by weight of the granule.

7. The termite controlling agent composition according to claim 2, wherein the formulation is the dust formulation.

8. The termite controlling agent composition according to claim 7, wherein the termite controlling agent composition contains 0.1 to 5 parts by weight of the dicloromezotiaz based on 100 parts by weight of the dust formulation.

9. The termite controlling agent composition according to claim 1, wherein the composition is in a formulation, and wherein the formulation is:
a rod; or
a bait formulation comprising a bait as feed for the termites prepared by impregnating a wood material and/or a cellulose base material with an active ingredient and/or by mixing the active ingredient into a solid.

10. The termite controlling agent composition according to claim 1, wherein the composition is a bait formulation and the termite controlling agent composition contains 0.1 to 10 parts by weight of the dicloromezotiaz based on 100 parts by weight of the bait formulation.

11. A method of controlling termites using the termite controlling agent composition according to claim 1, comprising:
transmitting the termite-killing effect of the dicloromezotiaz from one termite to another termite.

12. The method of controlling termites according to claim 11, wherein the method is any of soil treatment, termite trial treatment, and/or a baiting system, wherein the soil treatment comprises spraying and/or mixing the composition into soil, wherein the termite trail treatment comprises subjecting termite trails to treatment with the composition, and wherein the baiting system comprises placing the composition in the soil.

13. The method of controlling termites according to claim 11, comprising:
a step of performing soil treatment with a rod comprising the termite controlling agent composition; or
a step of performing the soil treatment by spraying and/or mixing the composition into soil, the termite controlling agent composition in any of a liquid, an emulsifiable concentrate, an aqueous suspension, and a granule.

14. The method of controlling termites according to claim 11, comprising a step of performing termite trail treatment by treating termite trails with the termite controlling agent composition in a dust formulation.

15. The method of controlling termites according to claim 11, comprising placing a baiting system comprising the termite controlling agent composition in the soil.

16. The method of controlling termites according to claim 11, wherein termites to be controlled using the termite controlling agent composition comprise Coptotermes formosanus Shiraki.

17. The method of controlling termites according to claim 11, wherein the termite controlling agent composition is in a formulation of any of a liquid, an emulsifiable concentrate, an aqueous suspension, a rod formulation compressed into a stick form or a chalk form, microcapsules, a dust formulation, a granule, and a bait formulation.

18. The method of controlling termites according to claim 17, wherein the formulation is the liquid, the emulsifiable concentrate, or the aqueous suspension, and the termite controlling agent composition contains 0.01 to 50 parts by weight of the dicloromezotiaz.

19. The method of controlling termites according to claim 11, wherein the composition is in a formulation, and wherein the formulation is:
a rod; or
a bait formulation comprising a bait as feed for termites prepared by impregnating a wood material and/or a cellulose base material with an active ingredient and/or by mixing the active ingredient into a solid.

20. The method of controlling termites according to claim 11, wherein the composition is a bait formulation and the termite controlling agent composition contains 0.1 to 10 parts by weight of the dicloromezotiaz based on 100 parts by weight of the bait formulation.
